(19) United States
(12) Patent Application Publication
(10) Pub. No.: US 2010/0151274 A1
(43) Pub. Date: Jun. 17, 2010

(54) FLEXIBLE SUBSTRATE AND METHOD OF MANUFACTURING THE SAME

(75) Inventors: Seung Youl KANG, Daejeon (KR); Gi Heon KIM, Daejeon (KR); Yong Hae KIM, Daejeon (KR); Sung Min YOON, Daejeon (KR); Chul Am KIM, Seoul (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/633,937

(22) Filed: Dec. 9, 2009

(30) Foreign Application Priority Data
Dec. 11, 2008 (KR) 10-2008-0125757

(51) Int. Cl. B32B 9/04; B05D 5/12; B05D 3/06; B05D 3/04

(52) U.S. Cl. 428/688; 427/58; 427/487; 427/569; 427/595; 427/126.3

(57) ABSTRACT

A method of manufacturing a flexible substrate is provided. The method includes coating a precursor including an inorganic polymer on the flexible substrate, curing the precursor including the inorganic polymer, and oxidizing a surface of the cured precursor including the inorganic polymer to form an oxide layer. Accordingly, an organic/inorganic barrier layer may be formed by only one coating process of a thin film. In this case, oxygen plasma or infrared ray/ozone processing may be performed at atmospheric pressure, thereby reducing process costs and equipment costs by not using vacuum equipment.

### CROSS-REFERENCE TO RELATED APPLICATION

This application claims priority to and the benefit of Korean Patent Application No. 10-2008-0125757, filed Dec. 11, 2008, the disclosure of which is incorporated herein by reference in its entirety.

### BACKGROUND

1. Field of the Invention

The present invention relates to a method of manufacturing a flexible substrate. More specifically, the present invention relates to a method of manufacturing a flexible substrate on which a barrier layer is formed.

The present invention relates to a method of forming a barrier layer on plastic used for a substrate of a flexible display or a flexible or plastic electronic device.

2. Discussion of Related Art

Unlike glass, since a plastic flexible substrate is light and is not easily broken due to its shock resistance, it can be attached to a bent surface and can be ultimately rolled or folded.

When a display or a flexible electronic device is formed on such a plastic substrate, a large screen can be rolled to reduce its volume and is not broken when it falls. Thus, it can be used as a portable display.

Since such a display can be installed along an attachment surface if necessary, it can variously be used as compared with an existing glass-based display. A flexible or printed electronic device formed on plastic will also become a very important electronic device.

In a display or an electronic device using general plastic as a substrate, the device is formed using an organic material on the substrate.

However, since an organic material is easily deteriorated by oxygen and moisture in general, the device needs to be encapsulated to protect the organic material from oxygen and moisture after the device is formed.

In order to maintain the flexibility of plastic, a technique such as thin film passivation may be used to secure moisture/oxygen permeation features after the device is formed. However, since the plastic substrate cannot perfectly intercept the permeation of oxygen and moisture from a lower substrate, it is very important to form a barrier on the substrate to prevent permeation of moisture and oxygen through the substrate as well as permeation of moisture and oxygen from an ambient after the formation of the device.

In order to prevent permeation of moisture and oxygen while maintaining the flexibility and light transmission of a plastic substrate, multi-layers including dual layers each having an organic layer and an inorganic layer have been conventionally suggested. This technology combines the flexibility of an organic layer and the moisture/oxygen permeation prevention characteristics of an inorganic layer, and when multi-layers are formed, it shows very excellent moisture/oxygen permeation prevention characteristics.

In order to form a barrier layer, after an organic layer is formed on a plastic substrate using a general resin or polymer coating method, it is cured using ultraviolet rays or heat. Inorganic layers such as silicon oxide layers, silicon nitride layers, or aluminum oxide layers are continuously deposited on the formed organic layer using vacuum equipments such as, sputtering, atomic layer deposition (ALD), or chemical vapor deposition (CVD). However, the organic layer is coated and cured at atmospheric pressure. In this case, since an inorganic layer needs to be deposited on the organic layer using vacuum equipments such as, sputtering, atomic layer deposition (ALD), or chemical vapor deposition (CVD), the process is complex and expensive.

### SUMMARY OF THE INVENTION

The present invention is directed to a flexible substrate in which an organic/inorganic composite layer can be formed by one coating process and one post-processing process.

One aspect of the present invention provides a method of manufacturing a flexible substrate including: coating a precursor including an inorganic polymer on the flexible substrate; curing the precursor including the inorganic polymer; and oxidizing a surface of the cured precursor including the inorganic polymer to form an oxide layer.

In curing the precursor, the precursor may be photo-cured or thermally cured.

In forming the oxide layer, a plasma using oxygen or oxygen mixed gas or UV (Ultra-Violet)/ozone may be performed on the cured precursor including the inorganic polymer.

The oxide layer may be formed at atmospheric pressure.

The precursor may be inorganic polymers including siloxane, metalloxane, or a mixture of siloxan, metalloxane, silazane and other inorganic polymers and so on. Also, the precursor may be mixture of inorganic polymers and organic polymers.

The curing of the precursor and the formation of the oxide layer may be continuously performed in a roll-to-roll process.

The coating of the precursor, the curing of the precursor, and the formation of the oxide layer may be repeatedly performed at least once to form multi-layers.

The concentration of the oxide layer may become lower as it goes toward the flexible substrate.

Another aspect of the present invention provides a flexible substrate including: a substrate; an organic layer formed on the substrate and including an inorganic polymer; and an oxide layer formed on the organic layer.

The organic layer and the oxide layer may be single-layered, and the concentration of the oxide layer may become lower as it goes toward the substrate.

The substrate may include at least two layers each having the organic layer and the oxide layer.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a cross-sectional view of a flexible substrate according to an exemplary embodiment of the present invention;

FIGS. 2 to 5 are cross-sectional views illustrating a process of manufacturing the flexible substrate of FIG. 1; and

FIG. 6 is a view for explaining a process of manufacturing the flexible substrate of FIG. 1 using a roll-to-roll process.

### DETAILED DESCRIPTION OF EMBODIMENTS

The present invention will be described more fully hereinafter with reference to the accompanying drawings, so that those skilled in the art can easily carry out the invention. This invention may, however, be embodied in different forms and should not be construed as limited to the embodiments set forth herein. Detailed descriptions of well-known functions and structures incorporated herein are omitted to avoid obscuring the subject matter of the present invention. The same reference numerals are used throughout the drawings to refer to the same or like parts.

It is to be noted that the terms “comprising” and “including” used throughout the specification should not be interpreted as being restricted to the means listed thereafter and do not exclude other elements.

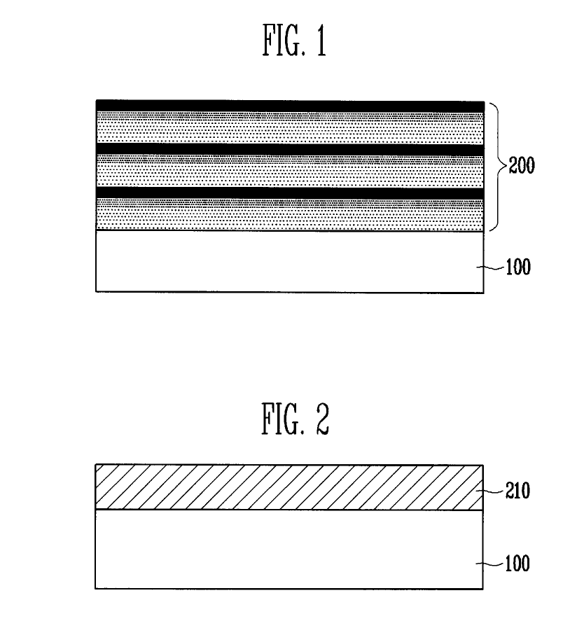

Hereinafter, a flexible substrate according to an exemplary embodiment of the present invention will be described with reference to FIG. 1. FIG. 1 is a cross-sectional view of a flexible substrate according to an exemplary embodiment of the present invention.

Referring to FIG. 1, the flexible substrate according to an exemplary embodiment of the present invention includes barrier layers 200 formed on a plastic substrate 100. The barrier layers 200 formed on the plastic substrate 100 consist of multiples of an unseparated inorganic/organic single-layers, i.e., an organic layer and an inorganic layer formed on the organic layer.

The inorganic layer and the organic layer are graded in composition. In the flexible substrate, through oxygen plasma or UV/ozone processing of the inorganic layer, the inorganic layer is formed to have a natural concentration difference according to the permeation depths of oxygen, so that the barrier layer 200 can be single layered and cannot be separated.

As illustrated in FIG. 1, the barrier layer 200 may be at least two stacked single-layers each having an organic layer and an inorganic layer. In the flexible substrate including the barrier layer 200, multiple single layers in which the flexibility of organic layers and the moisture/oxygen permeation prevention characteristics of inorganic layers are combined are stacked, thereby showing very excellent moisture/oxygen permeation prevention characteristics.

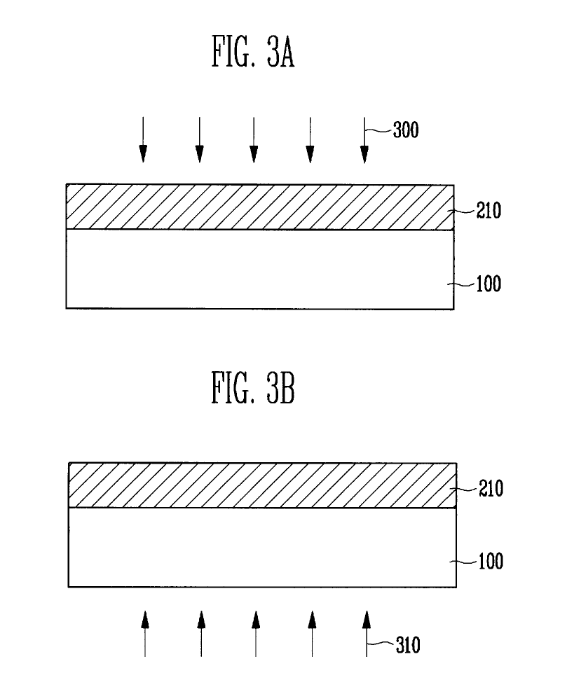

Hereinafter, a process of manufacturing a flexible substrate according to an exemplary embodiment of the present invention will be described with reference to FIGS. 2 to 5.

A precursor 210 is coated on a substrate 100 having flexibility like plastic to form a barrier layer.

In this case, an inorganic polymer is used as the material of the precursor 210, and a siloxane, metalloxane, or silazane-based inorganic polymer, other inorganic polymers, or a mixture of such an inorganic polymer and another general polymer may be used as the material of the precursor 210.

A metalloxane polymer may consist of titanium (Ti), aluminum (Al), or zirconium (Zr) in place of silicon of a siloxane polymer. The siloxane or metalloxane-based inorganic polymer has a repeated structure of the following formula.

R-(M-O)—R₁

where R and R1 may be hydrogen or an alkyl group and may have the same structure. M may be silicon (Si), aluminum (Al), titanium (Ti), or zirconium (Zr). In the formula, although M is an inorganic material and its chemical compound is an inorganic polymer, it has features of an inorganic material in which general polymers show. In other words, an inorganic material in the form of R bonded to a periphery of M has the features of an organic material, but if R is separated and is substituted with oxygen, a general oxide layer is formed.

In this case, a polymer mixed with an inorganic polymer is a thermoplastic resin, and may include at least one of poly-siloxane, low density polyethylene, high density polyethylene, ethylene-propylene copolymer, ethylene-butene copolymer, ethylene-hexene copolymer, ethylene-octane copolymer, ethylene-norbornene copolymer, ethylene-demon copolymer, polypropylene, ethylene-acetic acid vinyl copolymer, ethylene-methylmethacrylate copolymer, polyester (nylon-6, nylon-6,6, metaxylenediamine-adipic acid condensation polymer), or an amide-based resin such as polymethylmethacrylamide; an acrylic-based resin such as polymethylmethacrylate; polystyrene, styrene-acrylonitrile copolymer, styrene-acrylonitrile butadiene copolymer, a hydrogenated cellulose based resin such as triacetic acid cellulose, or diacetic acid cellulose; a halogen-containing resin such as polyvinyl chloride, polyvinylidene chloride, polyvinylidene fluoride, or polytetrafluorethylene; a hydrogen-bonded resin such as polyvinyl alcohol, ethylene-vinyl alcohol copolymer, or a cellulose derivative; polycarbonate; poly sulfone; polyester sulfone; polyetherether ketone; polyphenylene oxide; polymethylene oxide; and polyimide.

The chemical compound is a chain polymer (or oligomer). The chemical compound may be mixed with a solvent, or may be coated using a general coating method such as spin coating, dip coating, or bar coating.

Next, referring to FIGS. 3A and 3B, light or heat is applied to the coated precursor 210 to cause a crosslinking reaction.

A crosslinking reaction due to light or heat can be caused by controlling an end group of the inorganic polymer forming the barrier layer 200, i.e., the siloxane, silazane or metalloxane-based polymer. Accordingly, a curing reaction can be caused by adjusting a chain of the inorganic polymer and adding a photo or thermal curing agent. In particular, a photo curing agent makes a process very simple.

In further detail, when a solvent is used after coating the precursor 210, a preheat treatment process is performed to remove the solvent. The preheat treatment process is carried out at a temperature at which the solvent can be removed without causing a curing reaction, generally ranging from 50 to 150 degrees Celsius.

Referring to FIG. 3A, if the precursor 210 is designed to be photo-cured, the precursor 210 that has undergone the preheat treatment is photo-cured using UV (Ultra-Vilet) 300. Referring to FIG. 3B, if the precursor 210 is designed to be thermally cured, the thermal curing of the precursor 210 is performed by heat treatment 310.

In this process, the precursor 210 has a fine structure through the cross-linking reaction, and a high curing degree enhances resistance to all types of solvents.

The thermal curing for plastic may be performed at a temperature of less than 200 degrees Celsius in consideration of thermal characteristics of a plastic substrate. Meanwhile, in the case of photo curing, it is necessary to prevent damage to a plastic substrate due to UV (Ultra-Vilet).

Thereafter, referring to FIG. 4, a surface treatment process is performed on the cured precursor 210.

The surface treatment of the precursor 210 forming the barrier layer 200 may be achieved by plasma using oxygen or oxygen-mixed gas.

In this process, in an inorganic polymer, i.e., a siloxane, silazane, or metalloxane-based polymer, R2 (alkyl group) is substituted with oxygen, thereby causing a reaction as in the following reaction formula.

R₂-M-O+R₂-M-O→R₂O+—O-M-O-M-O—

In this process, organic parts including R (alkyl group) bonded to metals corresponding to M are removed from the coated surface of the inorganic polymer by oxygen, and the bonding is substituted with oxygen to finally form an oxide layer. Through this reaction, an oxide layer is formed on the top surface of the inorganic polymer, i.e., on a siloxane silazane, or metalloxane layer coated with the precursor 210 with the organic materials being removed. In this way, an inorganic layer is simply formed on an inorganic (metalloxane) polymer having features of an organic layer.

The oxygen plasma process can be performed using general vacuum equipments, but atmospheric pressure plasma equipment can eliminate problems occurring when a substrate is moved from an atmospheric pressure environment to a vacuum environment. Meanwhile, such formation of a surface oxide layer may be achieved by UV/ozone processing as well as a plasma processing.

As described above, formation of an oxide layer shows the same effect as a general method of forming a barrier layer, i.e. a general organic/inorganic layer stacking method. That is, an effect of forming an inorganic layer may be obtained by coating a metalloxane layer corresponding to an organic layer and then oxidizing a surface of the metalloxane layer.

In this case, referring to FIG. 5, a graded composition film may be formed by a difference between densities not of separated two layers but of a single layer, the difference in densities being naturally caused by difference in permeation depths of oxygen during oxygen plasma or UV/ozone processing.

Deep color parts are those whose densities of the oxide layer are high, and it can be seen that the gradation in concentration is automatically formed from upper to lower sides.

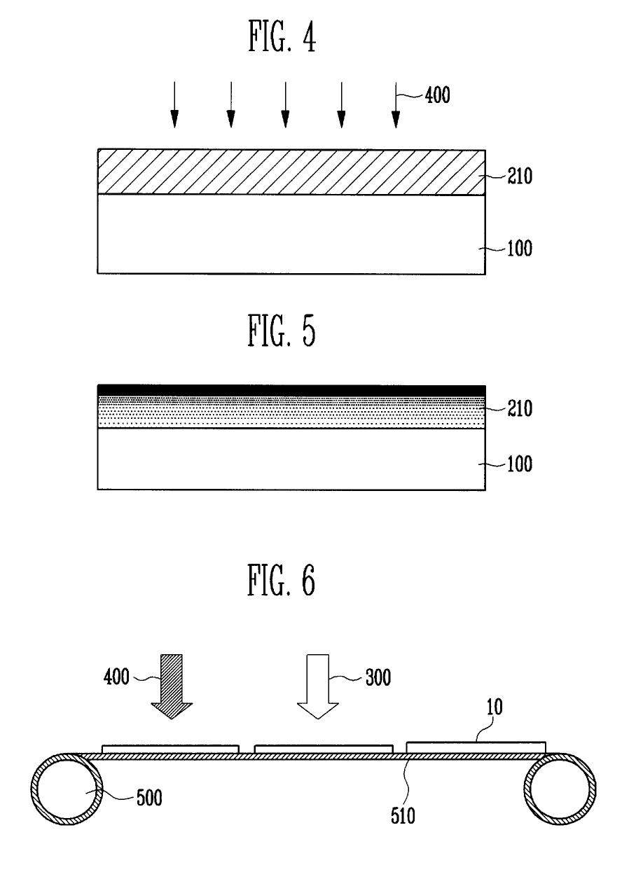

FIG. 6 is a view for explaining a simplified process of FIGS. 2 to 4.

Referring to FIG. 6, in roll-to-roll processing, after a plastic substrate is continuously loaded on a conveyor 510 located between rolls 500, stacking of inorganic polymers 10, photo or thermal curing 300 of the plastic substrate, and heat treatment 400 of the inorganic polymers 10 are sequentially performed at atmospheric pressure while the conveyor 510 is moving forward toward the opposite roll 500, forming a barrier layer having a single layer of an organic layer and an inorganic layer without additional movement of the plastic substrate.

According to the present invention, a barrier layer can be simply formed using organic/inorganic multi-layer thin films on a flexible substrate and a graded organic/inorganic composite barrier layer can be formed.

In particular, an organic/inorganic layer may be formed only once by coating of a thin film. In this case, since oxygen plasma processing or UV/ozone processing can be performed at atmospheric pressure, both equipment costs and process costs can be reduced by not using vacuum equipment.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method of manufacturing a flexible substrate, comprising:
coating a precursor including an inorganic polymer on the flexible substrate;
curing the precursor including the inorganic polymer; and
oxidizing a surface of the cured precursor including the inorganic polymer to form an oxide layer.

2. The method of claim 1, wherein in curing the precursor, the precursor is photo-cured or thermally cured.

3. The method of claim 1, wherein in forming the oxide layer, plasma processing of oxygen or oxygen-mixed gas or UV (Ultra-Violet)/ozone processing is performed on the cured precursor including the inorganic polymer.

4. The method of claim 1, wherein the oxide layer is formed at atmospheric pressure.

5. The method of claim 1, wherein the precursor is siloxane, silazane, metalloxane, or a mixture of siloxane, silazane, metalloxane, or inorganic polymers including metal oxide moieties, or mixtures of inorganic polymers and organic polymers.

6. The method of claim 1, wherein the curing of the precursor and the formation of the oxide layer are continuously performed in a roll-to-roll process.

7. The method of claim 1, wherein the coating of the precursor, the curing of the precursor, and the formation of the oxide layer are repeatedly performed at least once to form multi-layers.

8. The method of claim 1, wherein the concentration of the oxide layer becomes lower as it goes toward the flexible substrate.

9. A flexible substrate comprising:
a substrate;
an organic layer formed on the substrate and including an inorganic polymer; and
an oxide layer formed on the organic layer.

10. The flexible substrate of claim 9, wherein the organic layer and the oxide layer are single-layered, and the concentration of the oxide layer becomes lower as it goes toward the substrate.

11. The flexible substrate of claim 9, wherein the substrate includes at least two layers each having the organic layer and the oxide layer.
